(19) United States
(12) Patent Application Publication
(10) Pub. No.: US 2010/0025197 A1
(43) Pub. Date: Feb. 4, 2010

(54) Roller Strip for Constructing a Roller Conveyor

(75) Inventors: Erwin Gross, Deckenpfronn (DE); Steffen Kobs, Ehningen (DE); Werner Swoboda, Boeblingen (DE)

Correspondence Address: FACTOR & LAKE, LTD, 1327 W. WASHINGTON BLVD., SUITE 5G/H, CHICAGO, IL, 60607, US

(73) Assignee: Eisnmann Anlagenbau GmbH & Co. KG, Boeblingen (DE)

(21) Appl. No.: 12/515,079

(22) PCT Filed: Nov. 17, 2006
(86) PCT No.: PCT/EP06/11047

§ 371 Date: Jul. 7, 2009

(51) Int. Cl. B65G 13/02; B65G 13/075; B65G 13/06; B65G 39/02

(52) U.S. Cl. 198/784; 198/789

(57) ABSTRACT

The invention relates to a roller strip for constructing a roller conveyor, comprising a longitudinal carrier and a plurality of drive modules. Each drive module includes a roller and a drive for the roller, wherein a plurality of inserts are disposed along the longitudinal carrier for receiving the drive modules.

The invention relates to a roller strip, which comprises a longitudinal carrier, for constructing a roller conveyor.

Roller conveyors are used to transport goods carriers such as, for example, pallets. In the automobile industry vehicle bodies or parts of vehicle bodies are frequently transported by these between individual processing stations. In this connection the vehicle bodies are fastened to so-called “skids”. This term indicates transport frames which have two skid runners which are parallel to one another. During the conveying process the skid runners lie on rollers of the roller conveyor which are disposed in pairs and one behind the other in the conveying direction. If the rollers are rotated, the skid is conveyed in the conveying direction with the vehicle body fastened thereto.

The known roller conveyors are composed of individual roller track modules which in each case include a single electric drive motor. The drive motor is as a rule disposed between parallel roller strips in which the rollers are accommodated. In most cases the torque which is generated by the drive motor is distributed via belts among the driven rollers of one of the two roller strips.

These rollers are rigidly connected to the rollers on the other roller strip via shafts.

The object of the invention is to indicate how roller track modules for roller conveyors can be constructed in a simple and yet variable manner.

This object is achieved by a roller strip with a longitudinal carrier and a plurality of drive modules which in each case comprise a roller and a drive for the roller. A plurality of receptacles disposed along the longitudinal carrier are provided for accommodating the drive modules.

A self-contained modular sub-assembly is formed from the roller strip by using the drive modules. This sub-assembly is already functional per se in so far as the driven rollers can be rotated when the roller strip is connected to a voltage supply. It is not necessary to connect the rollers to an opposite roller strip.

The modular design of the roller strip in turn enables the roller strips to be disposed as desired relative to one another within broad limits. Thus the spacings (i.e. the track width of the roller conveyor) can be freely selected, as parallel roller strips do not have to be connected together. If a specific goods carrier requires, for example, three or more parallel roller strips for conveying, this can easily be achieved according to the invention by simply disposing a plurality of roller strips parallel to one another.

The not inconsiderable expenditure which was previously necessary for assembling the belts which, in the case of the known roller conveyors, transmit the torque from the central drive motor of a segment to the driven rollers is also eliminated by the individual independent drive modules. Furthermore, the frictional resistance caused by the belt drives and associated gear elements is reduced. This is particularly helpful in emergency operation, as must be maintained in the event of failure of one or a plurality of drive(s), for instance. For a low frictional resistance enables the goods carriers to be conveyed with just one driven roller or even pushed by hand on a roller track.

By dispensing with the belts between the rollers, the generation of noise is also reduced, which has a favourable effect on the expenditure which is required to observe the occupational safety regulations.

As the drive modules are accommodated in receptacles along the longitudinal carrier, they can be assembled in a very simple manner. It is also possible to provide more receptacles than drive modules, so that the roller pitch, i.e. the distribution of the drive modules along the longitudinal direction of the roller strip, is variable within certain limits. It is thus possible, with the same roller strips, to construct roller conveyors of quite different designs. When conveying relatively short goods carriers, the spacings between the driven rollers, for example, must be shorter than is the case where longer goods carriers are concerned. In the latter case it could suffice, for example, only to equip each second receptacle with a drive module.

The receptacles for accommodating the drive modules also have the advantage of facilitating the replacement of the drive modules in the event of defects or when the roller conveyor has to be modified.

It will generally suffice to accommodate just one roller in the drive modules. However it is basically also possible to dispose two or more rollers side by side or even one behind the other in a drive module.

It is optionally possible to provide additional free-running modules which include rollers without a drive. The receptacles are then to be formed such that both drive modules and free-running modules can be inserted in them. In the simplest case this can be achieved by giving the drive modules and the free-running modules similar dimensions and/or fastening elements. It is thus possible without any problems, for example, to insert additional free-running modules in free receptacles which are still available. Furthermore, free-running modules and drive modules can be interchanged if this proves to be favourable for improving the conveyance of the goods carriers. It is thus possible, for example, with a very low assembly expenditure, to change a conveying section over from a unilateral drive to a bilateral drive by replacing each second drive module by an originally opposite free-running module. It can be particularly easy to fasten the free-running modules with respect to the longitudinal carrier, as the free-running modules do not have to be secured in a rotationally rigid manner with respect to the longitudinal carrier.

In certain cases, for instance before a lifting station, it may be of advantage for safety reasons to use free-running modules into which brakes for the rollers are integrated. The goods carriers can thus be braked in a more controlled and reliable manner than when relying just on the braking action of the drives in the drive modules. However in this case, just like the drive modules, the free-running modules must be fastened in a rotationally rigid manner with respect to the longitudinal carrier. Appropriate connections for the brakes, which are preferably electrically actuated, are also to be provided in the longitudinal carrier.

The matter of how the receptacles are to be formed in detail in order to be able to accommodate the drive modules depends in the individual case, inter alia, on how compact a roller and the associated drive can be constructed as an entire module. If the drive is a hub drive, practically no construction space extending beyond the roller is required for the drive. The entire drive module then essentially has the form of the roller.

Compact and small drive modules can also be introduced into relatively small interspaces between side walls of a roller strip. If the longitudinal carrier of the roller strip is a profiled carrier, for example, the receptacles can comprise recesses in the profiled carrier. Guide elements which are formed at the drive module can then engage in the recesses, so that the entire drive module can be inserted in the profiled carrier and in the process automatically align in the profiled carrier.

In the simplest case the profiled carrier has two side walls, and the recesses comprise mutually opposite slots in the side walls. Guide elements which interact with the slots are formed at the drive modules. In this connection it is most favourable for the slots to extend into the side walls from above, so that the drive modules can be inserted in the profiled carrier from above. The guide elements should then guarantee that the drive module is fixed in a rotationally rigid manner with respect to the profiled carrier after being inserted in the slots.

The profiled carrier can be, for example, a hollow profile with a rectangular cross section. In order to form the receptacles for the drive modules, rectangular openings can then be cut into the hollow profile from the subsequent top side of the hollow profile, for example, into which openings the drive modules can be introduced. Slots which are worked into the side walls of the hollow profile enable insertion to take place from above and at the same time guarantee the rotationally rigid fixation.

It is even more favourable for assembly if the profiled carrier is a U-profile which is open in the upward direction. The profiled carrier is thus freely accessible from above over its entire length, which proves to be very convenient in assembly terms not just when inserting the drive modules, but also when laying the required electrical lines. In order to prevent dirt from penetrating after inserting the drive modules, the top side of the U-profiles, which is initially free, can be closed by suitable covers.

The receptacles for the drive modules do not have to be provided directly in the longitudinal carrier. The longitudinal carrier can instead serve solely as a kind of rail to which there are fastened a plurality of individual carriers which are separate from one another and in which a respective receptacle for a drive module is formed. Here the rails therefore essentially only cause the individual carriers to be precisely aligned, but do not directly accommodate the drive modules.

Further features and advantages of the invention will emerge from the following description of an embodiment on the basis of the drawings, in which:

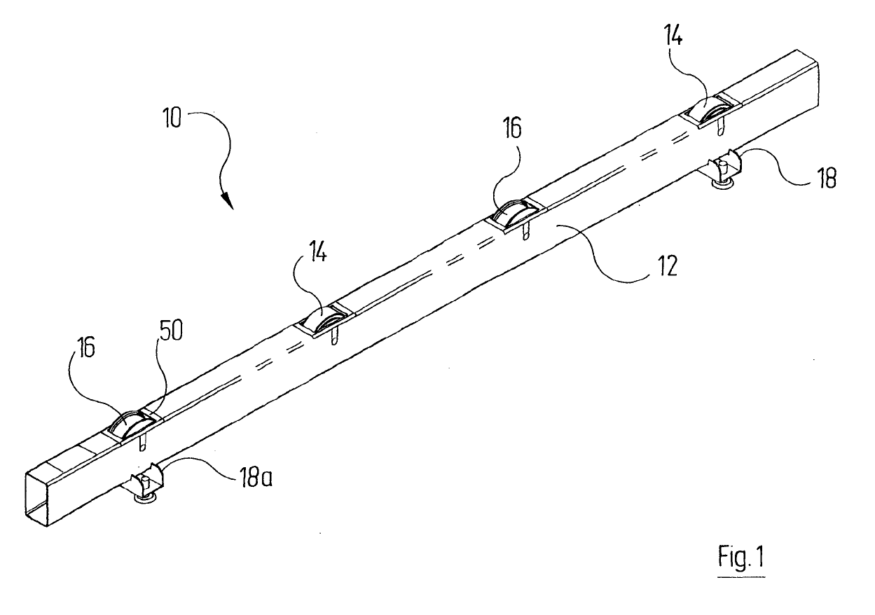

FIG. 1 shows a roller strip according to the invention according to a first embodiment in a perspective representation;

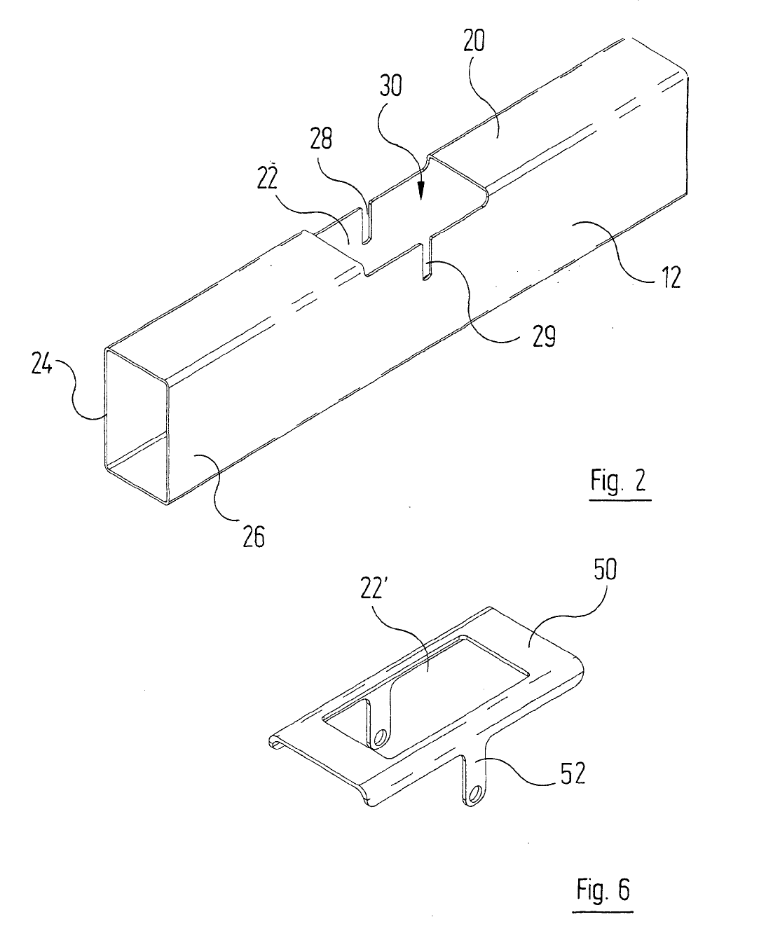

FIG. 2 shows an enlarged detail from the roller strip shown in FIG. 1 after constructing a drive module;

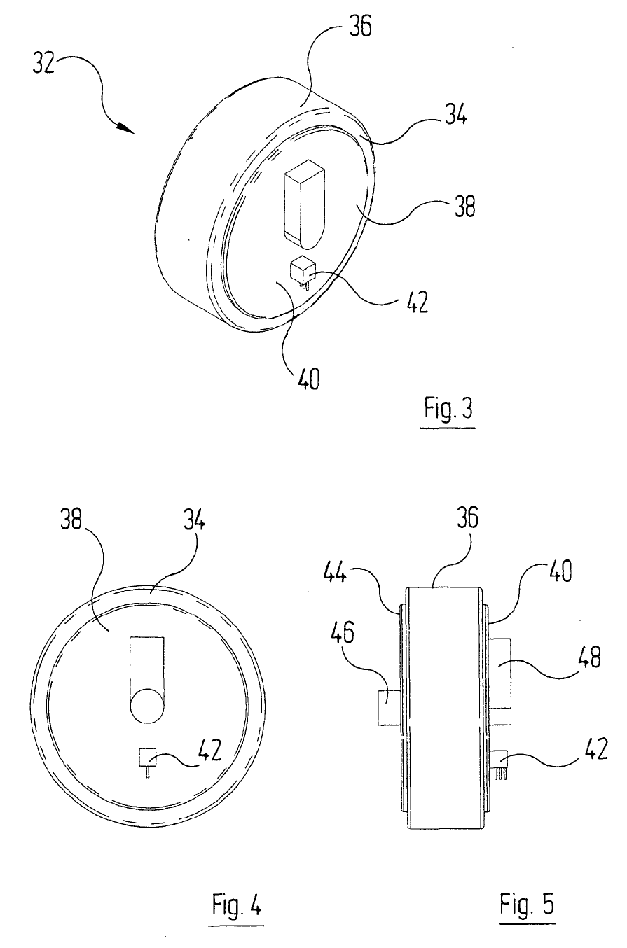

FIG. 3 shows a drive module which is part of the roller strip shown in FIG. 1 in a perspective representation;

FIG. 4 shows the drive module shown in FIG. 3 in a side view;

FIG. 5 shows the drive module shown in FIG. 3 in a front view;

FIG. 6 shows a cover part of the roller strip shown in FIG. 1 in a perspective representation;

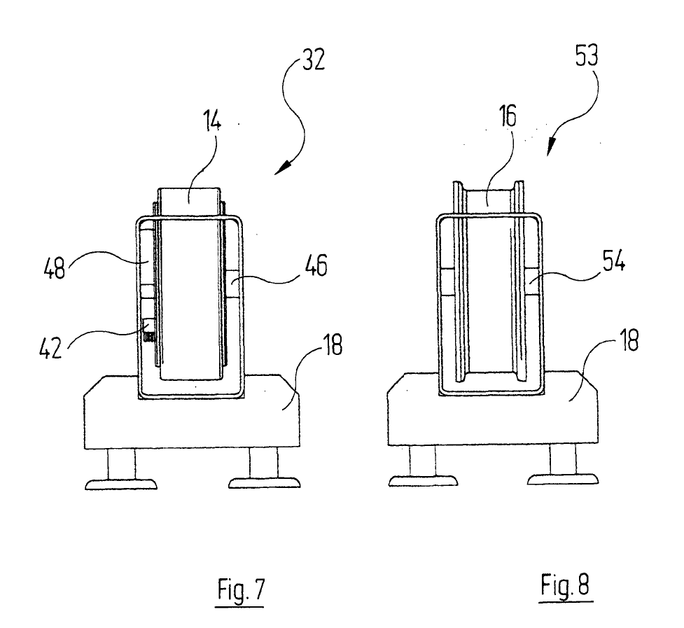

FIG. 7 shows the roller strip shown in FIG. 1 in a cross section, in which a drive module can be seen;

FIG. 8 shows the roller strip shown in FIG. 1 in a cross section, in which a free-running module can be seen;

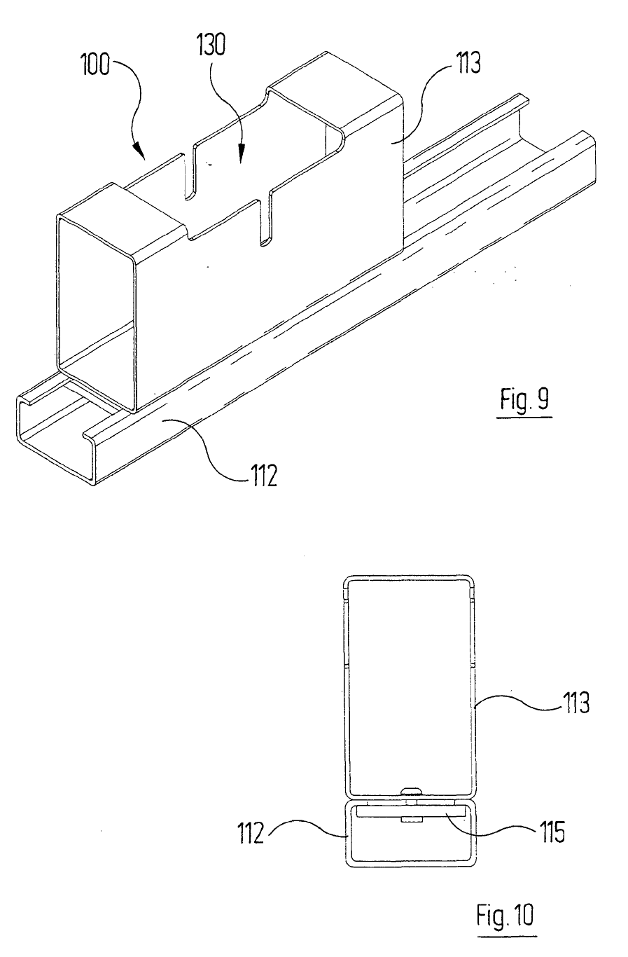

FIG. 9 shows an enlarged detail from a roller strip according to the invention according to a second embodiment after constructing a drive module;

FIG. 10 shows the roller strip shown in FIG. 9 in a cross section;

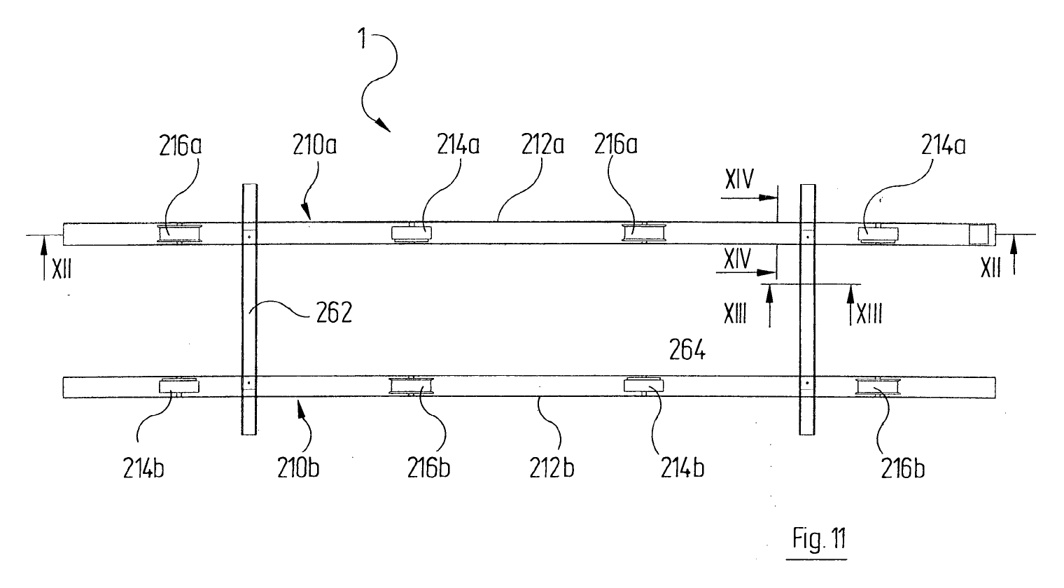

FIG. 11 shows a roller track module which is constructed from roller strips according to a third embodiment of the invention in a plan view;

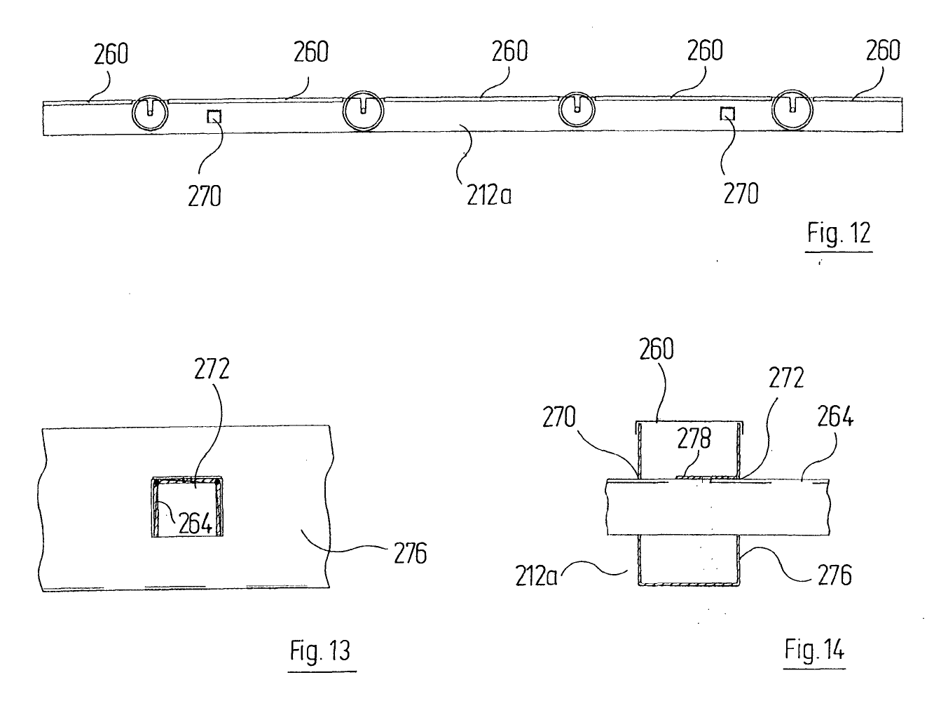

FIG. 12 shows a longitudinal section through a roller strip shown in FIG. 11 along the line XII-XII;

FIG. 13 shows a cross section through a crossmember which can be seen in FIG. 11 along the line XIII-XIII;

FIG. 14 shows a cross section through a roller strip shown in FIG. 11 along the line XIV-XIV.

A roller strip according to the invention is represented in perspective and marked as a whole by 10 in FIG. 1. The roller strip 10 comprises a longitudinal carrier 12 which is formed as a hollow profile with a rectangular cross section. Two driven rollers 14 and two idle rollers 16 are disposed alternately along the longitudinal direction of the longitudinal carrier 12 in the longitudinal carrier 12. The driven rollers 14 are unprofiled and bear a coating with a high frictional action. In the embodiment which is represented the idle rollers 16 have a profile with flanges on both sides. The flanges provide lateral guidance for the runners of the goods carriers which are to be transported.

The spacings between two adjacent rollers 14, 16 are equal and correspond to twice the spacing between the front sides of the longitudinal carrier 12 and the nearest roller.

An individual electric hub drive is associated with each of the driven rollers 14, which drive, with the rollers 14, in each case forms a compact drive module which is illustrated in detail in the following with reference to FIGS. 3 to 5.

In the represented embodiment a pair of profiled carriers 18, which embrace the longitudinal carrier 12 and are provided with vertically adjustable base elements, also form part of the roller strip 12. A further cut-out for accommodating a sensor ?? is provided at one or both front region(s) of the longitudinal carrier, with which sensor it is possible to detect the presence of a goods carrier for controlling the drives.

The two front sides of the longitudinal carrier 12 are open in order to provide access to cabling for the drives of the driven rollers 14.

FIG. 2 shows in an enlarged perspective representation a detail from the longitudinal carrier 12 prior to the insertion of a drive module. A cut-out 22, which is cut out of the longitudinal carrier 12 by means of a laser, for example, is located at the profiled surface 20 of the longitudinal carrier 12 which points upwards. Vertically extending guide slots 28, 29 are worked into the two side walls 24, 26 of the longitudinal carrier 12 in the same cutting process. Together with the guide slots 28, 29, the cut-out 22 forms a receptacle 30 for a drive module.

The drive module is shown in a perspective representation, a front view and in a side view, respectively, and marked as a whole by 32 in FIGS. 3, 4 and 5. The drive module 32 comprises a roller 34 with a running surface 36 and a hub 38 which is enclosed by the roller 34. A hub motor, with which the roller 34 can be rotated about an axis of rotation, is located in the hub 38. An electrical plug contact 42, via which the hub motor is supplied with an electrical voltage, is disposed at a first front side, marked by 40, of the drive module 32. The hub motor is also controlled via the electrical plug contact 42, preferably via a standardised bus system.

An elongated guide bolt 48 is also disposed on the first front face 40, which bolt is formed at its end pointing towards the axis of rotation of the roller 34 in exactly the same way as a guide pin 46 which is disposed on the opposite second front side 44 (see FIG. 5) in alignment with the axis of rotation of the roller 34 and rigidly connected to the hub 38.

When assembling the roller strip 10 the drive module 32 is firstly connected via the electrical plug contact 42 to electrical lines which extend in the longitudinal carrier 12. Contacting should take place before inserting the drive module in the receptacle 30, as afterwards the interior of the hollow profile is no longer easily accessible. The simplest method is to lift the electrical lines out of the longitudinal carrier 12 slightly for contacting in order to be able to establish the electrical connection without any problems.

The drive module 32 is now introduced into the receptacle 30. The guide pin 46 and the guide bolt 48 then engage in the guide slots 28, 29 of the longitudinal carrier 12. The drive module 32 is now fixed in the longitudinal direction of the longitudinal carrier 12 and also secured in a rotationally rigid manner with respect to the longitudinal carrier 12, as the guide bolt 48 cannot rotate in the guide slot 29. The drive module 32 can now also be secured against a vertical movement upwards, which can be achieved, for example, by means of a clamping element (not represented).

Since, generally speaking, only a relatively small part of the circumference should project upwards beyond the upward pointing profiled surface 20 of the longitudinal carrier 12, yet on the other hand it is as a rule necessary to protect the interior of the longitudinal carrier 12 against soiling, the gap which remains between the cut-out 22 and the roller 34 can be reduced by means of a cover part 50 which is shown in FIG. 6. The cover part 50 reduces the cut-out 22 to an extent such that the running surface 36 of the roller 34 can rotate past a cut-out 22′ of the cover part 50 at a small spacing. Downward reaching webs 52 are formed on the cover part 50 and can be connected to the longitudinal carrier 12 or also the guide pin 46 and/or the guide bolt 48.

FIG. 7 shows the drive module 32 in its assembled position inside the longitudinal carrier 12 in a cross section. FIG. 8 shows in a representation corresponding to FIG. 7 a cross section through a free-running module 53, which is formed from an idle roller 16 and a rotatable shaft 54. The outward projecting pivot pins of the rotatable shaft 54 are formed in exactly the same way as the guide pin 46 of the drive module 32, so that the free-running module 53 can also be inserted in the receptacles 30 of the longitudinal carrier 12. As the rollers 16 run freely, an anti-rotation mechanism with respect to the longitudinal carrier 12 is not absolutely necessary.

In the represented embodiment the idle rollers 16 have the same diameter as the driven rollers 14, so that the surrounding cut-outs 22 in the longitudinal carrier 12 can also be reduced with the cover parts 50 shown in FIG. 6 in the case of the free-running modules 53.

If neither a drive module 32 nor a free-running module 53 is to be inserted in a receptacle 30, the cut-out 22 can be closed by a suitable closing piece. The closing piece can then be formed in exactly the same way as the cover part 50 which is shown in FIG. 6, although no cut-out 22′ is provided there.

When assembling the roller strip 10 the drive modules 32 and the free-running modules 53 are inserted as described above in the regularly disposed receptacles 30 of the longitudinal carrier 12 and optionally fixed there. The cover parts 50 are then placed in position and likewise fastened. Two rollers strips 10 are disposed side by side at the desired spacing in order to construct a roller conveyor. The roller strips 10 are connected together in the longitudinal direction, preferably via plug-in shoes, after having previously connected the electrical lines inside the longitudinal carriers 12 via prefabricated electrical connections, e.g. plug contacts.

FIG. 9 shows in a representation which is based on FIG. 2 and is likewise in the form of a detail an alternative embodiment for a roller strip which is marked as a whole by 100. The roller strip 100 comprises, as the longitudinal carrier 112, a C-profile which is open in the upward direction and on which a roller block 113 is positioned. The roller block 113 is formed as a short hollow profile, as is similarly also shown in the detail of FIG. 2. The cross section of FIG. 10 shows that the roller block 113 is screwed to the longitudinal carrier 112 by means of a clamping plate 115. A drive module 32 with a driven roller or also a free-running module 53 with an idle roller can be inserted in the roller block 113 in the manner described above.

A plurality of roller blocks 113 are fastened to the longitudinal carrier 112 in order to construct a roller strip 100. The arrangement of the roller blocks 113 on the longitudinal carrier 112 can be selected as desired, so that there are no restrictions of any kind with regard to the roller pitch. The roller strip 100 is also distinguished by good accessibility of all the described parts. In order to protect the inserted drive modules 32 or free-running modules 53 against soiling, the open front sides of the roller blocks 113 can be covered with suitable closing plates. Covers can also be fitted to the open top side of the longitudinal carrier 112 between the roller blocks 113 in order to protect the electrical lines which are routed therein.

FIGS. 11 to 14 show a roller track module 1, which is constructed from roller strips according to a further embodiment, in a plan view and in sectional representations, respectively, along the lines XII-XII, XIII-XIII and XIV-XIV, respectively. Parts which are identical or correspond to one another in relation to the embodiment shown in FIG. 1 are given reference numbers which are increased by 200.

The roller track module 1 comprises two roller strips 210a, 210b which are disposed parallel to one another. As can best be seen in the cross section of FIG. 14, the roller strip 210a comprises a U-profile 212a which is open in the upward direction and covered by a cover 260. Covers 260 are also indicated in the longitudinal section of FIG. 12, although are not shown in FIG. 11 in order to provide a completely clear view onto the driven rollers 214a accommodated in the roller strip 210a and the idle rollers 216a. Here too the driven rollers 214 and the idle rollers 216 are again a component part of drive modules 32 and free-running modules 53, respectively, as has been explained above with reference to FIGS. 3 to 5 and FIG. 8.

The roller strips 210a, 210b essentially only differ from the roller strip 10 which is shown in FIG. 1 in that the longitudinal carriers 212a, 212b are not formed as hollow profiles, but as U-profiles. The U-profiles are disposed so that their open side points upwards. The roller strips 210a, 210b are thus more accessible when laying the electrical lines and also when connecting the latter to the drive modules 32. Protection against soiling is provided by the covers 260, which are positioned on the upwardly open sides of the U-profile and fastened in a way which is not shown.

In the embodiment which is represented in FIGS. 11 to 14 two roller strips 210a, 210b are connected via crossmembers 262, 264. The crossmembers 262, 264 are likewise in the form of U-profiles, the open side of which, however, points downwards. The side walls of the longitudinal carrier 212a comprise two pairs of square openings 270, 272, through which the crossmembers 262, 264 are passed. As can be seen in FIG. 14, the opening 272 at the inner side wall 276 of the longitudinal carrier 212a is produced by cutting this open along a line which has the form of an upwardly open U-profile. The strap 278 which is produced as a result is then bent so far inwards into the longitudinal carrier 212a until it extends horizontally. The strap 278 now serves as a fastening strap for the upward pointing side surface 280 of the crossmember 264.

The connection of the crossmember 264 to the roller strip 210b and the connections of the other crossmember 262 take place in a corresponding manner.

1. A roller strip for constructing a roller conveyor, the roller strip including a longitudinal carrier and further comprising:
a) a plurality of drive modules which in each case comprise a roller and a drive for the roller, and
b) a plurality of receptacles disposed along the longitudinal carrier for accommodating the drive modules.

2. The roller strip of claim 1, further comprising free-running modules which include rollers without a drive, wherein the receptacles are formed to accommodate both drive modules and free-running modules.

3. The roller strip of claim 2, wherein the free-running modules comprise brakes for the rollers.

4. The roller strip of claim 1, wherein the longitudinal carrier is a profiled carrier, and the receptacles comprise recesses in the profiled carrier.

5. The roller strip of claim 4, wherein the profiled carrier has two side walls and the recesses comprise mutually opposite slots in the side walls, wherein guide elements that interact with the slots are formed at the drive modules.

6. The roller strip of claim 4, wherein the profiled carrier is a U-profile which is open in the upward direction.

7. The roller strip of claim 4, wherein the profiled carrier bears covers between the drive modules.

8. The roller strip of claim 1, wherein a plurality of individual carriers which are separate from one another are fastened to the longitudinal carrier,—which carriers a respective receptacle for a drive module is formed.

9. A systems for constructing a roller conveyor, comprising:
a) a plurality of longitudinal carriers;
b) a plurality of drive modules which in each case comprise a roller and a drive for the roller; and
c) a plurality of receptacles disposed along the longitudinal carrier for accommodating the drive modules.

10. The roller strip of claim 2, wherein the longitudinal carrier is a profiled carrier, and the receptacles comprise recesses in the profiled carrier.

11. The roller strip of claim 3, wherein the longitudinal carrier is a profiled carrier, and the receptacles comprise recesses in the profiled carrier.

12. The roller strip of claim 5, wherein the profiled carrier is a U-profile which is open in the upward direction.

13. The roller strip of claim 5, wherein the profiled carrier bears covers between the drive modules.

14. The roller strip of claim 6, wherein the profiled carrier bears covers between the drive modules.
